(19) United States
(12) Patent Application Publication
(10) Pub. No.: US 2001/0034623 A1
(43) Pub. Date: Oct. 25, 2001

(54) Automatic registration system, as for lodging or other application

(76) Inventor: Kevin Kwong-Tai Chung, Princeton, NJ (US)

Correspondence Address: DANN DORFMAN HERRELL & SKILLMAN, SUITE 720, 1601 MARKET STREET, PHILADELPHIA, PA, 19103-2307, US

(21) Appl. No.: 09/776,788

(22) Filed: Feb. 5, 2001

Related U.S. Application Data
(60) Provisional application No. 60/184,410, filed on Feb. 23, 2000.
(60) Provisional application No. 60/198,704, filed on Apr. 20, 2000.

(51) Int. Cl. G06F 17/60

(52) U.S. Cl. 705/5

(57) ABSTRACT

A registration system associates a customer, such as by a personal identifier, with a data record relating to a particular facility at a particular property or location, or other premises and issues an access card containing an access identifier for such particular facility. The access card includes a memory to which data such as the access identifier may be written and from which data such as the personal identifier may be read, such as by an electronic lock or other access control device. The registration system cooperates with a property management system for the property and, alternatively, may also cooperate with a personnel management system.

This Application claims the benefit of U.S. Provisional Application Ser. No. 60/184,410 filed Feb. 23, 2000 and of U.S. Provisional Application Ser. No. 60/198,704 filed Apr. 20, 2000.

The present invention relates to a registration system and, in particular, to a registration system issuing an access card.

In a typical conventional hotel or other lodging establishment, for example, an arriving guest must wait to be served by a clerk at a registration desk and, after having his reservation confirmed, is checked in and is issued a room key. The room key in modem establishments is typically a plastic card having an access code stored electronically in a magnetic stripe or mechanically in holes or dimples in the card. At certain times, such as late afternoon and early evening for check-in, and at certain times in the morning for check out, the registration desk is very busy and guests may encounter undesirable delays. Such delays are exacerbated by conventions, conferences and the like, where large numbers of guests, possibly up to 50-75% of the capacity of the property, seek service to either check-in or check-out within a very short time period.

Many establishments such as lodging companies and hotel chains, auto rental companies and airlines, operate a plurality of properties or locations or other premises that may be corporately owned or may be franchised or otherwise affiliated. The properties are typically in widely dispersed locations, whether within a region or a country, or world-wide. As a marketing tool to encourage repeat business by its customers, many such establishments and companies have a so-called “loyalty” program or “frequency” program, i.e. a program that provides “points” or “miles” based on purchases of services and/or goods by persons registered in the loyalty program. Such loyalty programs are centrally administered for efficiency and consistency. In addition, each property typically utilizes a property management computer in each particular location or premises, i.e. a computer system utilized for controlling guest reservations and registration, tracking the availability and status of various rooms and facilities at the particular property location, for billing including accumulating room, parking, restaurant and other charges to the guest's account, and for crediting loyalty program accounts.

Where the establishment has a so-called loyalty program, the guest's loyalty program identification, typically a number or a card, is utilized to credit the guest's loyalty account with an appropriate credit based on the lodging and/or other services and/or goods purchased. Access to the establishment's loyalty program records is typically via a network connection between the property management computer in the particular location or premises and a central computer, if such network connection is available and sufficiently low in cost as to be economically feasible.

Similar delays and problems are faced by passengers of airlines and other forms of transportation, by renters of automobiles and other vehicles, by participants at a convention or conference, and the like

It would be desirable to have a system that would eliminate the need for each person to be served by a clerk or other service worker at a registration desk, and would also be desirable to have a system that did not require a substantially continuous network connection to a central computer.

In addition, each property or location or other premises may also have an personnel management system, such as a time clock or computer system for recording the times and dates each employee, service person or contractor reports for work and departs the property or location or other premises. It would be desirable if such personnel management system were to be coordinated with the property management system.

Accordingly, there is a need for a system and apparatus that registers a customer and issues an access card to the customer.

To this end, the present invention comprises a processor and a memory operably coupled thereto, a user interface including a display for displaying registration information relating to the premises and a data entry for entering user information, the user interface being operably coupled to the processor for coupling the registration information and the user information therebetween. A card issuing device provides an access card having a card memory and is operably coupled to the processor for coupling information related to the registration information and the user information to be stored in the card memory of the access card for enabling access related to the premises.

### BRIEF DESCRIPTION OF THE DRAWING

The detailed description of the preferred embodiments of the present invention will be more easily and better understood when read in conjunction with the FIGURES of the Drawing which include:

FIG. 1 is a schematic block diagram of an exemplary embodiment of a registration apparatus and system in accordance with the invention;

FIGS. 2A and 2B are schematic diagrams illustrating alternative exemplary arrangements for a card issuing device suitable for the embodiment of FIG. 1;

FIG. 3 is a schematic diagram, partly in block diagram form, of an alternative exemplary card issuing device suitable for the embodiment of FIG. 1;

FIG. 4 is a schematic flow diagram relating to the operation of the exemplary apparatus and system of FIG. 1 in accordance with the invention;

FIG. 4A is a schematic flow diagram for a portion of FIG. 4 relating to an alternative operation of the exemplary apparatus of FIG. 1;

FIGS. 5A through 5H are exemplary screen displays that can be produced by the embodiment of FIG. 1;

FIG. 6 is a schematic block diagram of an exemplary electronic lock suitable for use in accordance with the invention; and

FIG. 7 is a schematic block diagram of a personnel management system in accordance with the invention.

In the Drawing, where an element or feature is shown in more than one drawing figure, the same alphanumeric designation may be used to designate such element or feature in each figure, and where a closely related or modified element is shown in a figure, the same alphanumerical designation primed may be used to designate the modified element or feature. It is noted that, according to common practice, the various features of the drawing are not to scale, and the dimensions of the various features are arbitrarily expanded or reduced for clarity.

### DESCRIPTION OF THE PREFERRED EMBODIMENTS

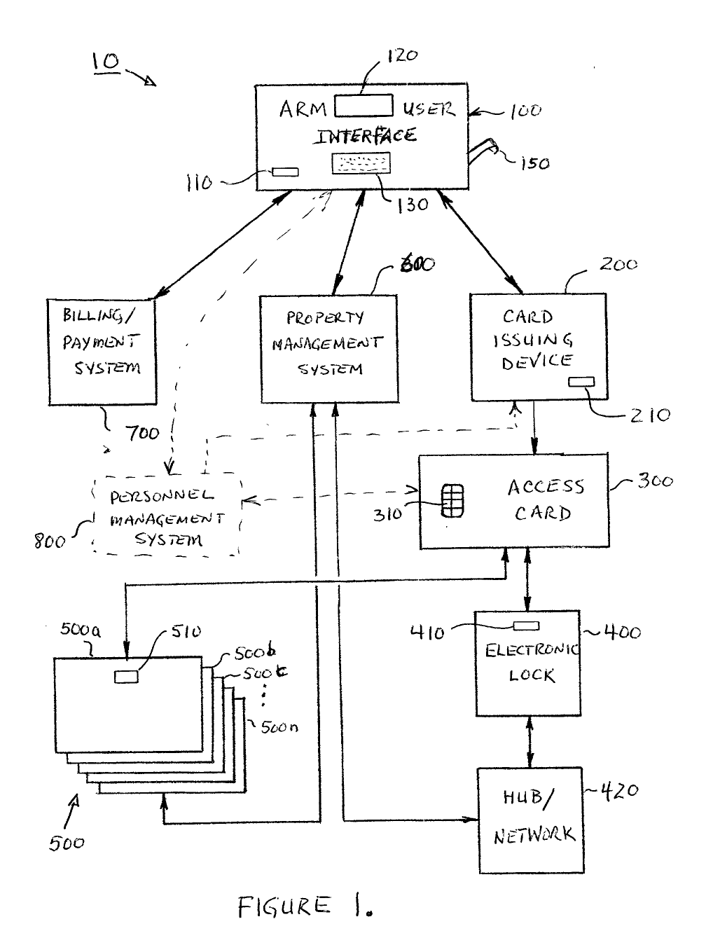

FIG. 1 is a schematic block diagram of an exemplary embodiment of a registration apparatus and system 10 in accordance with the invention. Apparatus 10 is sometimes referred to as an automatic registration machine (ARM) and system 10 is sometimes referred to as an automatic registration system. Apparatus and system 10 allow a customer, such as a hotel guest, and airline passenger, an auto renter, a conference participant, a renter of a self-storage unit, and the like, to register and receive an access card that enables the full or partial access to certain facilities and/or services at a property or location or other premises, and optionally to check out, all without the necessity of intervention by personnel of the property or location or other premises. While apparatus and system 10 is capable of providing such features, the management of the property or location or other premises may desire to interpose their personnel at one or more times for various reasons, e.g., to offer information or solicit questions, to provide a more “personal touch,” or to gauge customer satisfaction.

For convenience, and without limiting the businesses, properties, locations, goods and/or services, with which the invention may be employed, the invention will principally be described in terms of a hotel and a guest at the hotel, in connection with an access card 300 for allowing entry to a room locked by means of an electronic or electromechanical door lock, for example, entry to an assigned guest room or suite as well as entry into the hotel through exterior entrances during times when such entrances are locked to prevent entry by unauthorized persons. Card 300 may also be utilized to allow access to various hotel facilities and services such as restaurants, coffee shops, game rooms, athletic/exercise facilities and equipment therein, gift shops and other stores, conference rooms, business centers and equipment therein, and the like. ARM 10 may also gather credit and billing information and verify and/or authenticate the guest's credit and billing information, and may optionally process the credit and/or billing transaction or the making of payment.

Registration system 10 comprises an ARM user interface 100 for use by a guest, typically upon arrival at the property or location or other premises. User interface 100 includes a processor, memory, user display 120 and user data entry device 130, such as those commonly utilized for use with personal computers, automatic teller machines (ATMs), point-of-sale terminals, and the like, i.e. for credit, banking, financial or other transactions, all generally referred to herein as credit transactions. The computer and operating software of user interface 100 produces displays of screens of information in a sequence that easily and conveniently elicits necessary information and leads the guest through the registration process step by step. Upon the successful completion of registration, an access card is automatically issued that contains coded information sufficient to identify the guest and to operate the electronic locks for those rooms and facilities to which the guest is authorized access. System 10 may employ one or more ARM user interfaces 100, as is desired, and each user interface 100 is preferably associated with a card issuing device 200.

User interface 100 is operatively coupled such as by at least an electronic link to access card issuing device 200, and may also be operatively coupled such as by one or more electronic links to various other systems, such as to a property management system 600, a billing and/or payment system 700. Such electronic link(s) may be by network such as a local area network or Ethernet or the Internet, or by telephone, radio, infrared or other means of communication, or by any combination thereof, as may be any link described herein. Card issuing device 200 operates to issue an access card 300 upon the successful completion of registration and is typically attached to or housed in the same container as is user interface 100.

Access card 300 may be a conventional magnetic stripe card which has a very limited memory capacity and has no processing capability, but is preferably a “smart card” or “super smart card” that includes at least a processor and a memory of substantial capacity, e.g., 2-8 kilobytes. Smart cards provide superior security as compared to magnetic stripe cards, and may contain various information files and fields providing plural levels (e.g., 3 or 4 levels) of security using hardware, software and/or firmware security codes. In addition, the various information files and fields may be utilized to enable predetermined selected access to different areas and facilities 500 under different conditions and at different times. For example, access cards issued to guests in suites or other premium accommodation may be enabled for access to certain amenities, such as lounges and health spas that are not available to guests registered for lesser accommodations, in addition to access to a guest room via an electronic lock 400. An access card issued to a guest in a normal room may be enabled to access only the guest's room via electronic lock 400, and may also be enabled to allow access to certain facilities 500, such as a restaurant, a swimming pool or to a fitness center during certain hours such as off-peak hours.

Electronic locks 400 and other access devices associated with various rooms, areas, facilities and services 500, . . . each include a card reader for reading information stored in the memory of access card 300, and may be referred to generically as “access devices.” Such access devices can include, for example, electronic locks, gate and door openers, television pay-per-view boxes, telephones, health and exercise room locks, check-out terminals at shops and restaurants, and the like.

Smart card 300 may be of the contact card type that has contacts 310 that are coupled to a card reader and/or writer via electromechanical contacts, or may be of the contact-less or wireless type that is coupled to a card reader and/or writer by electromagnetic, capacitive, electro-optical or other non-contact means of communication. When the registration transaction is completed and the appropriate access codes have been stored in the memory of an access card 300, the access card 300 is issued to the guest via slot 210. Where the proprietor has a loyalty program that utilizes a smart card or super smart card as a loyalty card, such loyalty card may be utilized as the access card 300 in accordance with the invention. In such case, the loyalty card is inserted into slot 210 of device 200 and is returned after the registration transaction is completed and the appropriate access codes have been stored in the loyalty card memory. Information coded into the memory of card 300 includes, for example, identification of the selected or assigned room, length and/or dates of stay, loyalty program information, and any other information the proprietor deems appropriate for its sales, inventory, loyalty program or other purpose.

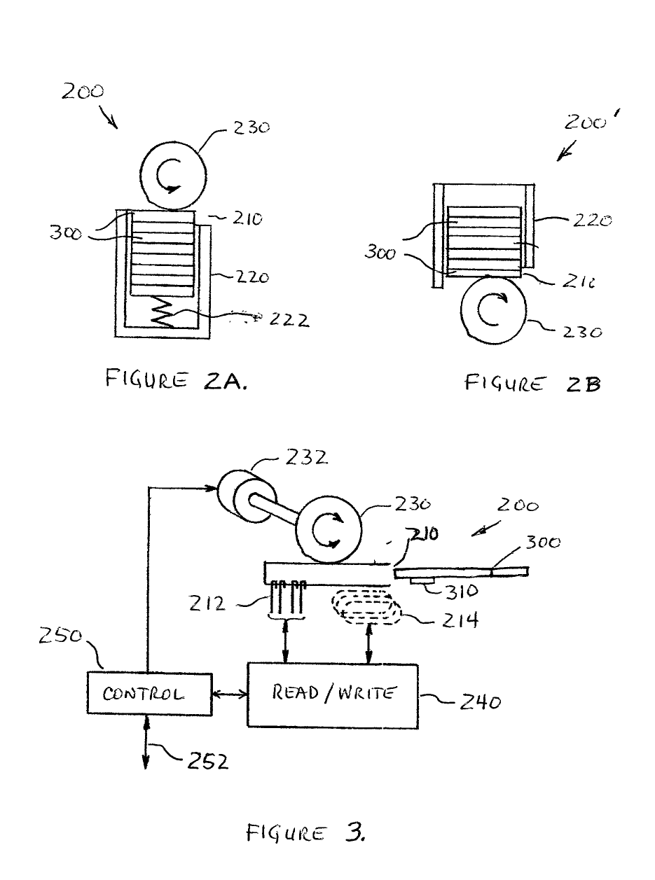

Card issuing device 200, sometimes also referred to as a card-issuing module or a card-issuing machine, includes a card dispenser such as those shown in the schematic diagrams of FIGS. 2A and 2B which is suitable for the embodiment of ARM 10 of FIG. 1. In FIG. 2A, a container 220 contains a stack of access cards 300 that is urged upward and into contact with dispensing wheel 230 by a spring 222 at the bottom of container 220, which is sometimes called a “rotary-push machine.” The stacked cards 300, which may be magnetic stripe cards or smart cards, are in proper orientation and/or sequence for proper writing of information to the memory thereof. One wall of container 220 is shorter than the other by about the thickness of cards 300 so as to provide a dispensing clot 210 as shown. Dispensing wheel 230 is rotated by a suitable predetermined amount in the direction indicated by the circular arrow each time a card 300 is to be dispensed, thereby to move a card 300 through slot 210. Card 300 may pass through a card writer or coder as it travels from container 220 to slot 210 or may be inserted into another slot to be placed in suitable proximity to such writer/coder. The alternative arrangement of device 200′ of FIG. 2B is inverted from that of FIG. 2A except the container 220 is above dispensing wheel 230 so that the stack of cards 300 bears against dispensing wheel 230 under the force of gravity. Otherwise, dispensers 200 and 200′ operate similarly.

FIG. 3 is a schematic diagram of alternative exemplary card issuing device 200 suitable for the embodiment of FIG. 1. Proximate slot 210 are a plurality of electromechanical contacts 212 for contacting the pattern of electrical contacts 310 of smart card 300 when smart card 300 is inserted into slot 210. Electrical signals are coupled between contacts 212 and read/write circuitry 240 which decodes signals from smart card 300 and codes information to be coupled to smart card 300. Read/write circuitry 240 is under the control of control 250 for sending information signals to card 300 and for receiving information signals from card 300. Control 250 is responsive to the ARM user interface 100 via data line 252, which may be bidirectional where information is transmitted in both directions between user interface 100 and card 300, and is further responsive thereto for energizing electric motor 232 to rotate either clockwise or counterclockwise as is appropriate for taking in and dispensing smart card 300. Alternatively, where smart card 300 is a wireless card, device 200 includes an electromagnetic coil or antenna 214 coupled to read/write circuitry 240 for communicating information to and from card 300.

Returning to FIG. 1, user interface 100 is operatively coupled to property management system 600 which typically includes at least one computer and operating software as is conventional for making, monitoring and controlling guest reservations and registration, including check-in and check-out at the property or location or other premises. Property management system 600 also typically includes links to various property or location facilities and/or services 500, such as restaurants, shops, television, telephone, business center, health and exercise facilities, housekeeping, maintenance, and the like, identified as 500a, 500b, 500c, . . . 500nin FIG. 1, for purposes of authorizing access and for receiving usage reports, availability and status information, charges and purchases and the like, as well as for management, monitoring, accounting and billing purposes, for example.

The primary use for access card 300 is usually to provide access for a properly registered and checked in guest to a particular guest room, as well as access to the property through exterior doors and/or gates, for example. The guest takes the access card 300 issued by card issuing device 200 and inserts it into a slot 410 of electronic lock 400 on the assigned guest room, exterior door or gate, or associated with any other space, facility or facilities. Because smart cards 300 may contain various information files and fields providing plural levels (e.g., 3 or 4 levels) of security using hardware, software and/or firmware security codes, selective access to various facilities, entrances and exits may be provided by a single card. Further, because the specific authorizations and permissions are programmed into access card 300 when it is issued, they may be customized for each guest at essentially zero marginal cost.

Electronic lock 400 may be linked or coupled to property management system 400, such as via a hub and/or a network 420, for receiving guest access authorization information such as the currently valid access number or other access identifier or identifiers stored in the memory of access card 300 for unlocking the room when the access card 300 having the proper access identifier stored therein is inserted in slot 410. A typical hub or network linking the electronic locks 400 of a property to other systems could employ any convenient data communication protocol, such as the standard RS232 or RS485 protocol.

Electronic lock 400 need not be electronically or otherwise linked to property management system, in particular where access card 300 is a smart card, which offers a great advantage in that it eliminates the need for costly infrastructure wiring or other communication link in the property or location or other premises. For this arrangement, electronic lock 400 includes, in addition to a card reader, other functions that enable it to process information read from smart card 300 for the purpose of granting or denying access, as is described in greater detail below. Such other functions typically include a memory and a processor, information stored in firmware, a battery or other source of electrical power, and a clock or other timekeeping device. A typical access device 400 such as an electronic lock has sufficient memory for storing records of at least the 20 most recent access card uses, and preferably 100 or more such uses. Where use information is stored in access card 300, the memory thereof is preferably of similar capacity.

Guest access to facilities and/or services 500a, 500b, 500n is by insertion of access card 300 into a slot 510 at the location of each such facility and/or service. slot 510 is associated with an access device such as an electronic lock, gate release or access recording device similarly to access devices 400. Where access card 300 is a smart card 300, the communication link between facilities and/or services may be eliminated where the information that otherwise would be transmitted to or received from property management system 600 is stored in the memory of smart card 300, for example, at the time of registration and check in, as well as with each use of access card 300, and is read from the memory of card 300 at the time of guest check out using user interface 100 by a reader such as that of card issuing device 200 and transmitted to property management system 600.

The memory of electronic access devices 400, 500, as well as the memory of access card 300 where access card 300 is a smart card, contains at least two, and preferably four, different levels or segments of memory for matching with different levels of access authorization, such as guest access (typically, the most limited access, such as to a particular room and certain amenity areas), worker access (typically, limited access to certain work areas as well as to certain guest areas, commensurate with work duties), management access (typically, a more expansive access commensurate with management duties) and supervisory access (typically complete access). For security, each level of memory is typically for at least two bytes.

User interface 100 is operatively coupled to a billing and/or payment system 700, such as a point-of-sale system, an ATM system or other bank or credit provider system, for the purpose of verifying and authenticating guest credit information and/or receiving credit/debit authorization and/or payment electronically, whether by conventional or by other methods. To this end, user interface 100 includes a card slot 110 into which such credit card may be inserted or through which such credit card may be passed for reading and/or writing information between the memory of the credit card and user interface 100. Where a personal identification number (PIN), personal security code (PSC) or other personal identifier or verifying information is required for processing the transaction, such is entered utilizing data entry device 130. At completion of registration or check out, or at any other convenient time during the registration or checkout process, the credit card is returned to the guest—the credit card is not utilized as access card 300.

Herein, the term “credit card” is used to refer to any one or more of credit cards, debit cards, charge cards, cash cards, money cards, bank cards, other cards for making a purchase, transaction, billing and/or payment, and the like, whether of the magnetic stripe or smart card variety. Further, any use of such card, whether to verify credit or identity, authorize credit or charges, charge or purchase goods and/or services or other purchases or advances of money, or to effect billing and/or payment and/or transfer of funds, is considered a credit transaction, whether completed contemporaneously or over an extended period of time, and whether in a single session of plural sessions, whether referred to as such or as billing or payment or other type of transaction.

Further with regard to user interface 100, display device 120 may be a conventional computer display or may be a touch-screen display by means of which at least certain guest information and responses are taken. Display 120 can be, for example, a cathode ray tube display, a liquid crystal display (LCD) or any other suitable display. Data entry device may be an alphanumeric keyboard or a numeric keypad that is separate from display 120, or may be an alphanumeric or numeric display on a touch-screen display 120, as is desired.

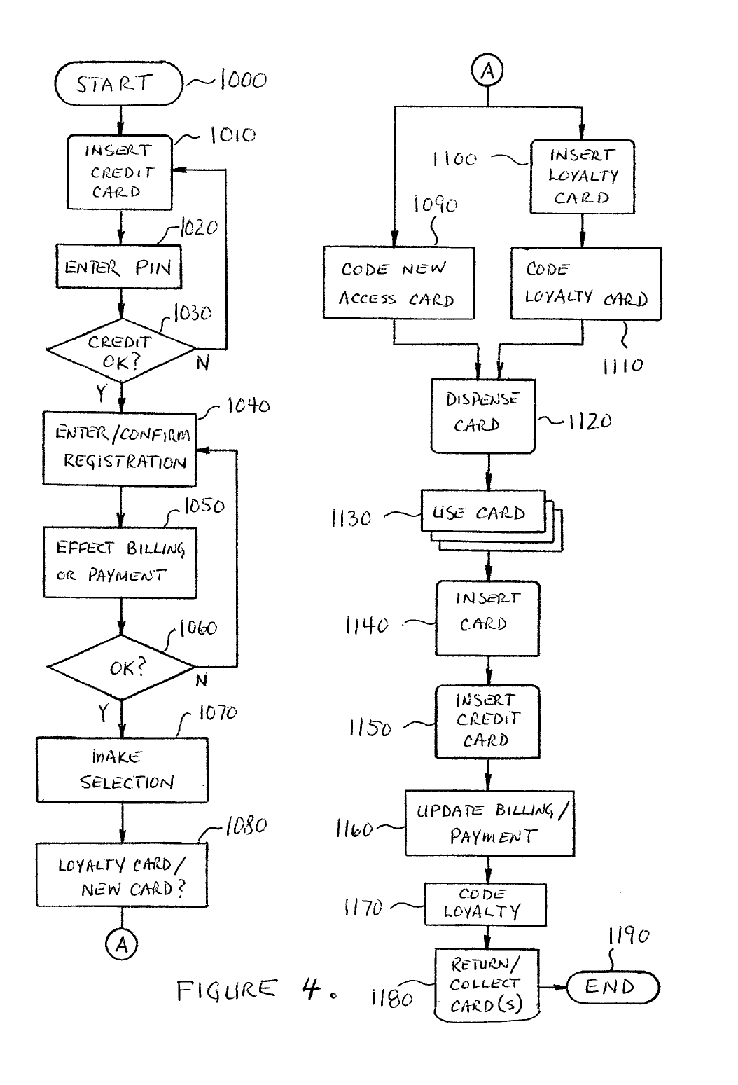

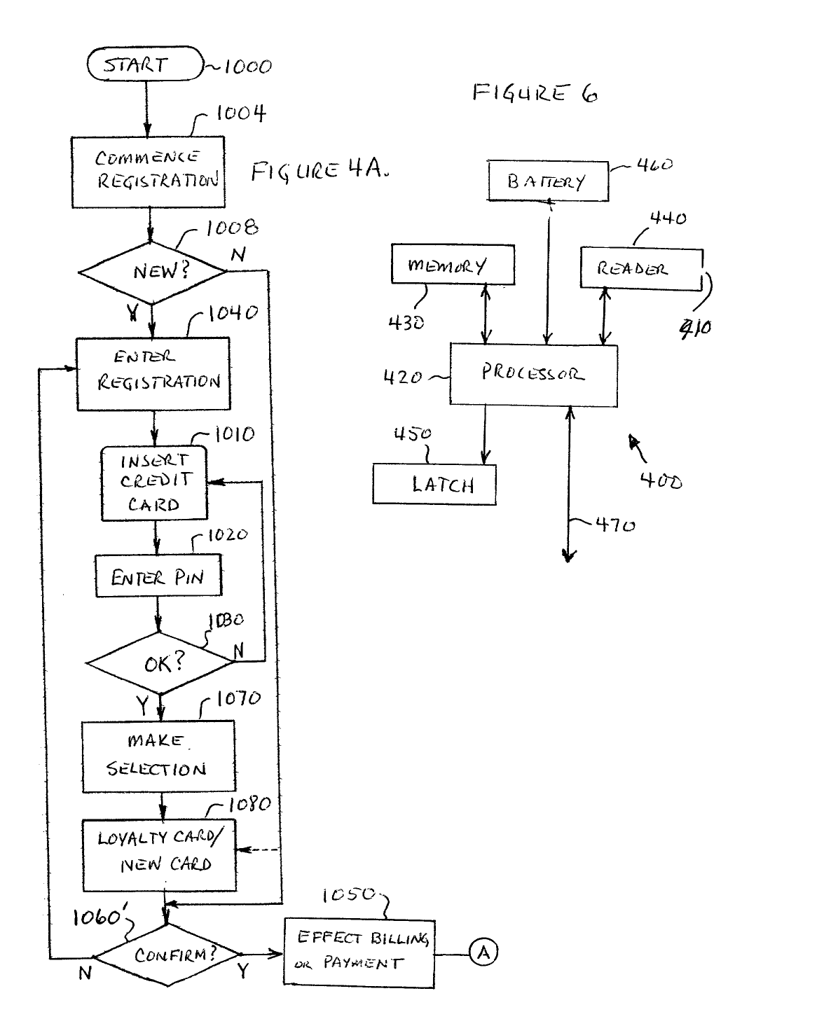

FIG. 4 is a schematic flow diagram relating to the operation of the exemplary apparatus and system 10 of FIG. 1 in accordance with the invention. The process starts 1000 and a credit card is inserted 1010 by the person using the system (herein the “user”). Initiation of the process may be responsive to, for example, insertion of a credit card, insertion of a loyalty card, pressing a button or clicking on a button displayed on display 120. At the beginning of the registration process, perhaps even before a credit card is inserted, a welcome screen of information is typically displayed to the user to introduce the registration procedure, provide instructions, advertisement for the property and/or provide other information.

When the user inserts his credit card, as a security feature, the user typically is requested to enter and enters 1020 a PIN number, personal security code or other security code or identifier and, if the entered identifier and/or the credit card is determined 1030 to be valid, the yes “Y” path is followed and the registration process commences. If the credit determination 1030 fails, for example, either because the credit card is invalid or expired, the available credit is insufficient, the identifier is incorrect or expired, or credit is otherwise denied, as is determined, for example, by a credit card issuer or a credit issuing agency or clearing house, the no “N” path is followed and the user may try again or use a different credit card.

The user then enters 1040 that a new registration is to be made or that an existing registration or reservation is to be confirmed. In the latter case, the pre-registered user enters 1040 an identifier of the preregistration, e.g., a reservation or confirmation number or his/her name, and the process immediately goes to the access card issuing (providing) steps 1080 et seq. unless the user indicates that he desires to make a change to the preregistration. User interface 100 obtains information concerning the preregistration from property management system 600, proceeds to effect the billing or payment 1050 via billing system 600 and utilizes the preselected room selection 1070 associated with the preregistration.

For a new registration or a changed preregistration entered in step 1040, the user enters new information and/or changes previously entered information regarding the type of room, room preferences, length of stay, loyalty program and the like all in step 1040. Such may be implemented as separable portions of step 1040 (such as information about the user, room type and preferences and/or length of stay) or as an integrated step 1040, as is desired. Step 1040 may optionally enter a default entry, such as a one-day stay in a single-bed room, if the user does not make any response within a given time, e.g., 30 seconds. When the user confirms the information entered, the system 10 effects 1050 the billing to a credit card or payment from a debit card or cash account, or otherwise effects arrangements for billing and payment, such as via billing payment system 700. Any error or missing information, or any failure to effect satisfactory billing and/or payment arrangements, produces a negative verification 1060, and the “OK?” test 1060 is negative and follows the “No” path “N” so that correction can be made in steps 1040 and/or 1050. If all is satisfactory, the “OK?” test 1060 is positive and follows the “Yes” path “Y” to step 1070 for the user to make a selection of the particular room that he desires from among the available rooms of the type and kind for which he has registered. Selection 1070 may be implemented as separable portions of step 1070 (such as information about the user, room preferences and/or length of stay) or as an integrated step 1070, as is desired. If the user fails to make a selection within a given time, e.g., 30 seconds, then a default selection from the rooms available of the type selected may be made by the ARM 10, either of the next listed room or based on certain criteria, which criteria may be selected by the property manager.

Once the selection 1070 is made, the system 10 prompts the user to designate 1080 whether or not he will be using a loyalty card. If the user does not have a loyalty card, does not have the loyalty card with him or does not desire to use his loyalty card, or if the user designates 1 180 for a new access card 300 to be issued, the designation 1080 is for a new access card 300 to be issued and the system 10 proceeds to step 1090 wherein the reader/writer 200 codes 1090 the pertinent registration, identification and access information into a new access card 300, and then dispenses 1120 such coded new access card 300 so that the user may take and use same.

If, on the other hand, the user has and desires to use a loyalty card as an access card 300, he designates 1080 the loyalty card and the system proceeds the step 1100 to prompt the insertion of the loyalty card into the card reader/writer 200. Upon insertion 1100 of the loyalty card into the reader/writer 200, reader/writer 200 codes 1110 the pertinent registration, identification and access information into the loyalty card, and then dispenses 120 such coded loyalty card so that the user may take and use same as an access card 300.

The user may use 1130 the access card 300 for various purposes and facilities 500 of the property or location or other premises as the coded access or loyalty card is coded to permit, such as for access to a guest room and various exterior entrances, parking facilities and the like, for access to other facilities such as a lounge, pool, health spa, and the like, and for making purchases at various facilities such as restaurants, coffee shops, gift shops, business centers, television and telephone, and the like. Where the access card 300 is a smart card rather than a magnetic stripe card, more information may be stored therein and usage by the user is attended by greater security. Information concerning such use may be communicated to the property management system 600, if desired, or if the access card 300 is a smart card, such information may be stored into the memory of the smart access card 300 at each use for later reading at the time of check out.

Check-out generally encompasses steps 1140 through 1190. When the user ends his stay, check out may be effected by using the access card 300 with the ARM user interface 100 described above. The user inserts 1140 the access card 300 into either slot 110 of user interface 100 or slot 210 of card issuing device 200 as directed, and also, at least optionally for verification of identity and credit, inserts 1150 his credit card into user interface 100. Information from the property management system 600 regarding the use to which the access card 300 has been put and/or information read from the access card 300, particularly if the access card 300 is a smart card, is utilized for determining the total charges amassed by the user and updating 1160 the amount of the billing and/or payment, such as by transmitting such information to the billing system 700 for effecting billing and/or payment.

If the user elected to utilize his loyalty card as his access card 300 for the stay, information relating to the length of stay and/or amounts spent for lodging and/or other products and services is coded 1170 into the memory of the loyalty card and may also be transmitted to a central computer for the loyalty program, either directly or via the property management system 600, and the loyalty card is returned to the user.

If the user has used an access card 300, that card may be, and preferably is, collected 1180 by the card reader/writer 200 of the ARM user interface 100, and if the user has used his loyalty card as an access card 300, the loyalty card is returned 180 by the card reader/writer 200 of the ARM user interface 100 to the user. Optionally, if the ARM 10 is enabled to allow the user to register for a loyalty program, the access card 300 could either have loyalty program registration information stored therein so as to become the user's loyalty card or a separate loyalty card could be issued either by the ARM 10 immediately following registration or indirectly by other means.

If an access card 300 is reported as lost, such as by a user or by its having been found and given to the property staff, ARM 10 is operated to cancel or invalidate this access card 300. This is accomplished by one or more ways. A user upon discovering his access card 300 to be lost is expected to either return to user interface 100 or notify the property staff of such fact. The user may insert his credit card into user interface 100 and respond by entering certain identifying information such as via a touch screen 120 or data entry device 130 and so effect the canceling of the lost card and the providing of a replacement card. Replacement card 300 is coded to cause electronic lock 400 to immediately cancel the previous card, if cancellation has not already been effected by user interface 100 via property management system 600. Alternatively, property staff may insert the turned-in lost card 300 into a user interface 100 or enter via a data entry device 130 information identifying the lost card 300, whereby the card 300 and authorizations enabled for such card 300 may be canceled or disabled.

Each time a properly authorized access card is used with a lock 400 for which it is authorized it cancels the previous card authorization(s) stored in the memory of that lock 400 and takes precedence over any earlier access cards used with that lock 400. Thus, a newly-issued or replacement access card 300 will be differently coded from previously issued access cards 300 and will when inserted into electronic lock 400 will cancel the information stored in the memory of lock 400 relating to the previously used cards 300, thereby rendering them inoperative. This feature not only provides for simple replacement of lost cards 300, but also provides automatic changing of the codes for authorizing access to a particular electronic lock 400 as new access cards 300 are issued to subsequent guests. Further security is provided by the record of recent card usage that is stored in card 300, lock 400, or both.

If a user fails to check out by the end of the stay for which he is registered, e.g., by the check-out time, or within a reasonable predetermined time thereafter, ARM may be programmed to automatically process the checking out of that user, to cancel or invalidate his access card 300 and to effect billing or payment to the credit card utilized at check in. At the completion of check out, any card that is properly returnable to the user, e.g., a credit card or loyalty card, is returned by user interface 100 and or card issuing device 200, and a printed receipt is preferably issued to provide the user a tangible and preferably itemized record of his stay and the items charged. Thus ends 1190 the process of the automatic registration system 10 herein.

FIG. 4A is a schematic flow diagram for a portion of the flow diagram of FIG. 4 relating to an alternative operation of the exemplary apparatus 10 of FIG. 1 in which the ordering of steps 1000 to “A” differs. Blocks in FIG. 4A of like number to blocks in FIG. 4 are of like function. The process starts 1000 and the user commences registration (or check in) 1004 by taking some action at the ARM user interface 100, such as pushing a button, clicking on a button or inserting a credit card or other card. In response to a prompt, such as a selection on a welcome screen, the user indicates whether the registration is new or a preregistration. If the registration is new or is to be changed from a preregistration, the determination 1008 NEW? is positive and the yes path “Y” is followed for accomplishing registration, If the registration is not new, i.e. is a reservation or preregistration without change, then determination 1008 NEW? is negative and the path “N” is followed leading to confirmation 1060′.

For a new or changed registration, the user enters 1040 registration information of the sort described herein to register. The user inserts 1010 his credit card and enters 1020 the PIN, security code or other identifier associated therewith, such as via keyboard 130, for the purpose of verifying credit. If the user's credit is OK? 1030, the path “Y” is followed and registration continues with the making of selection 1070, as above, of a particular room and/or facility 500 access and the like. If not, path “N” is followed and the user has opportunity to provide correct information and/or insert 1010 another credit card. The user also has opportunity to select 1180 to use a loyalty card as an access card 300 or to receive a new access card.

Having entered all information required to complete registration and check in, or to have a complete preregistration accepted, the user now has opportunity to confirm 1060′ the correctness of all the information concerning his registration, as by clicking on a button, e.g., a “Yes” button or a “No” button, or a “Confirm?” button. If the registration is confirmed, decision 1060′ follows the positive or “Y” path to effect 1050 billing and payment and issuance of an access card 1090, 1100, 1110, 1120 as described above, in particular with respect to FIG. 4. If the registration is not confirmed, e.g., as where some information is deemed by the user to be incorrect or in need to be changed for another reason, the process follows the negative or “No” path and returns to step 1040 where the user is lead through the registration process again and may change any or all of the information previously entered.

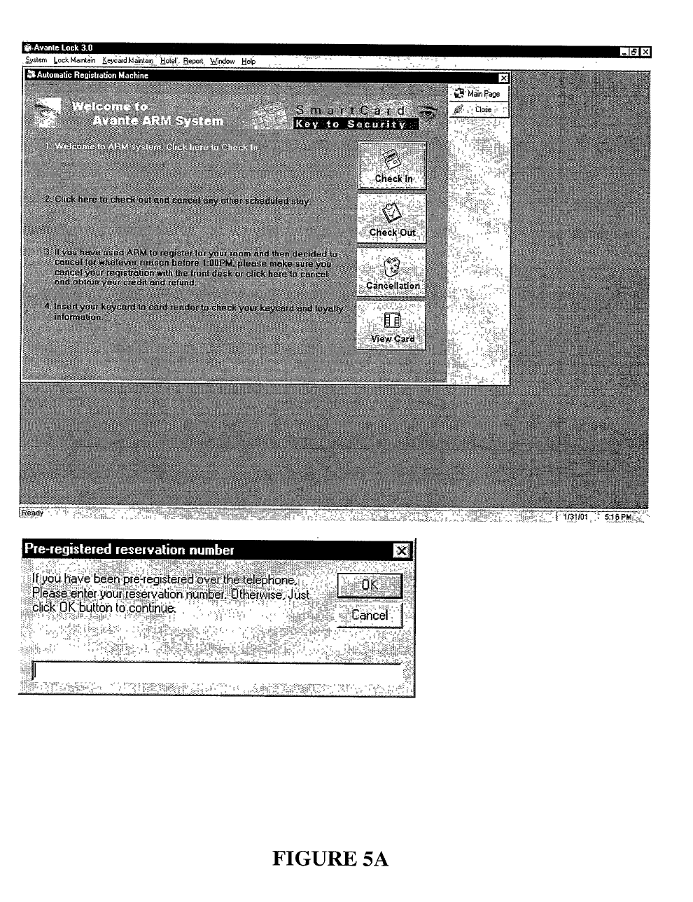

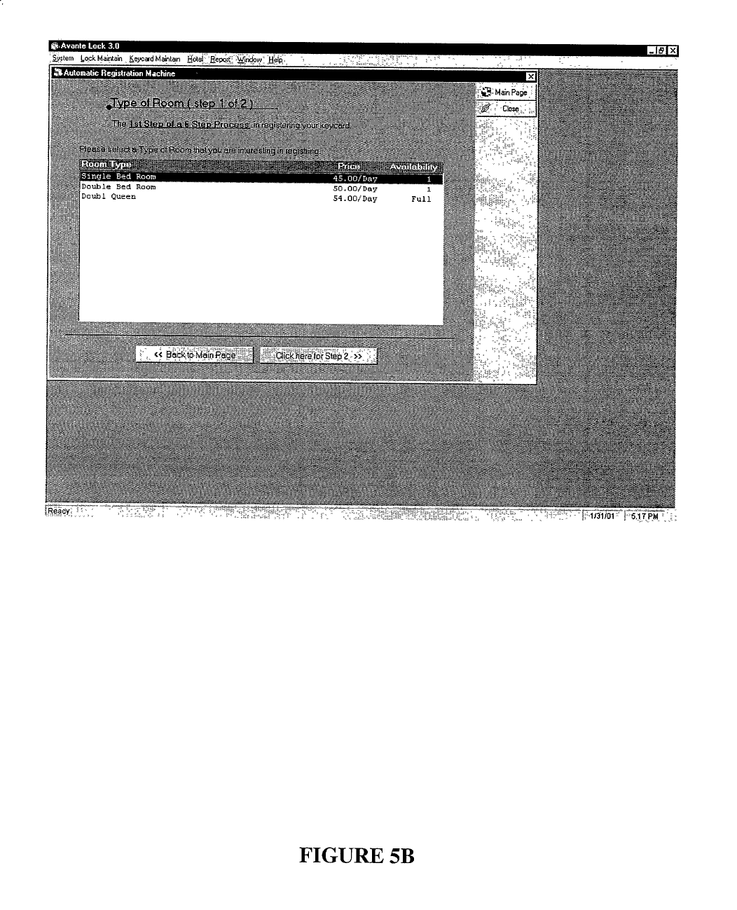

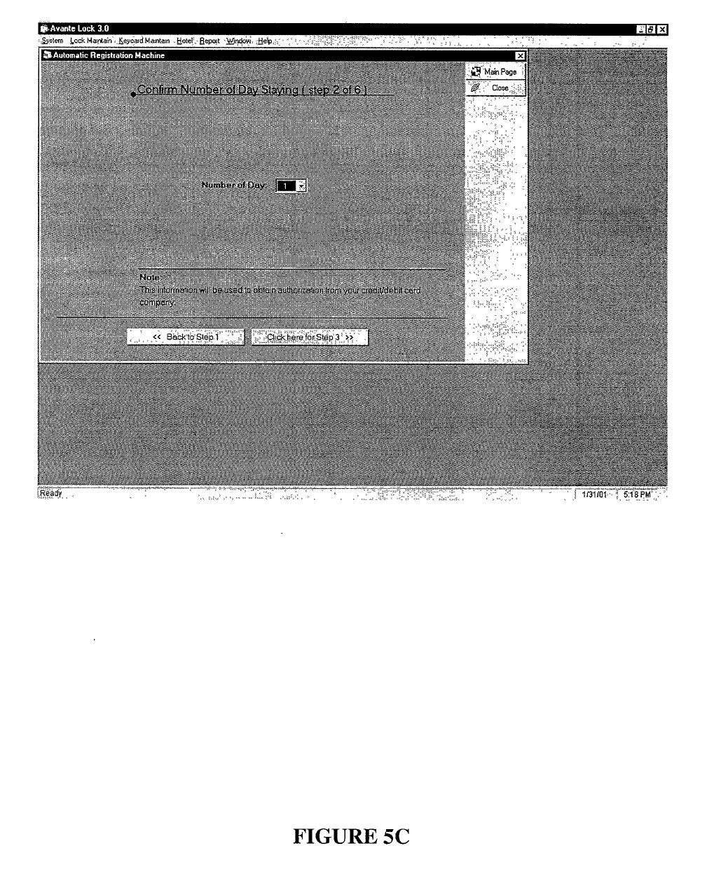

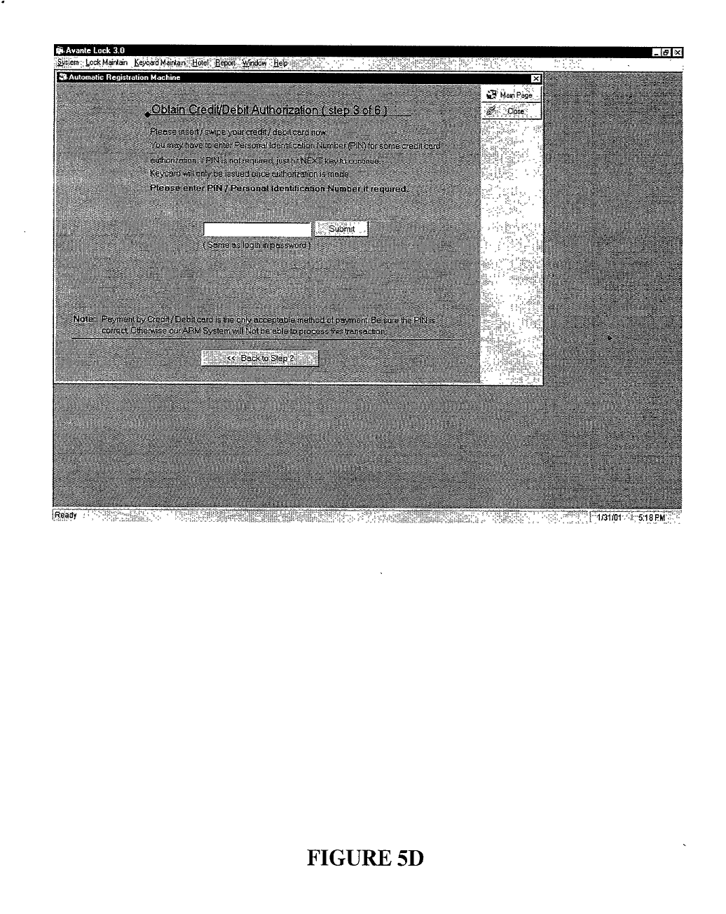

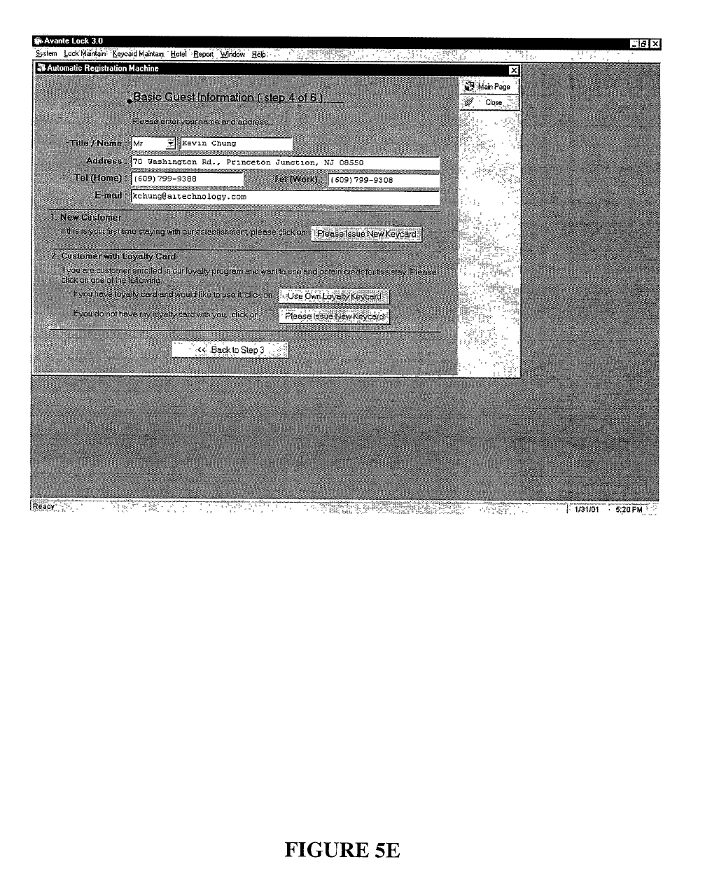

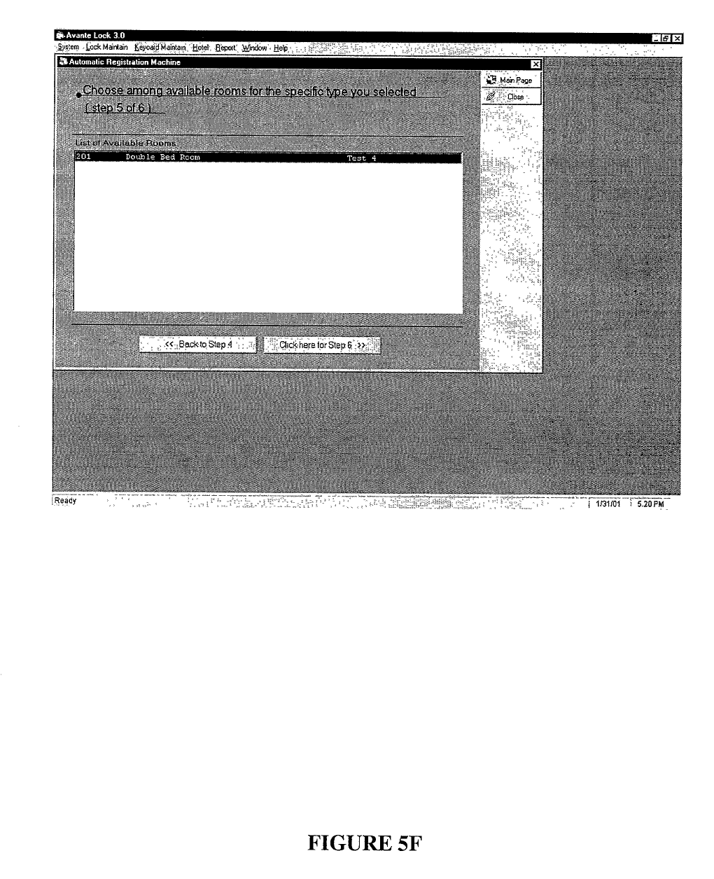

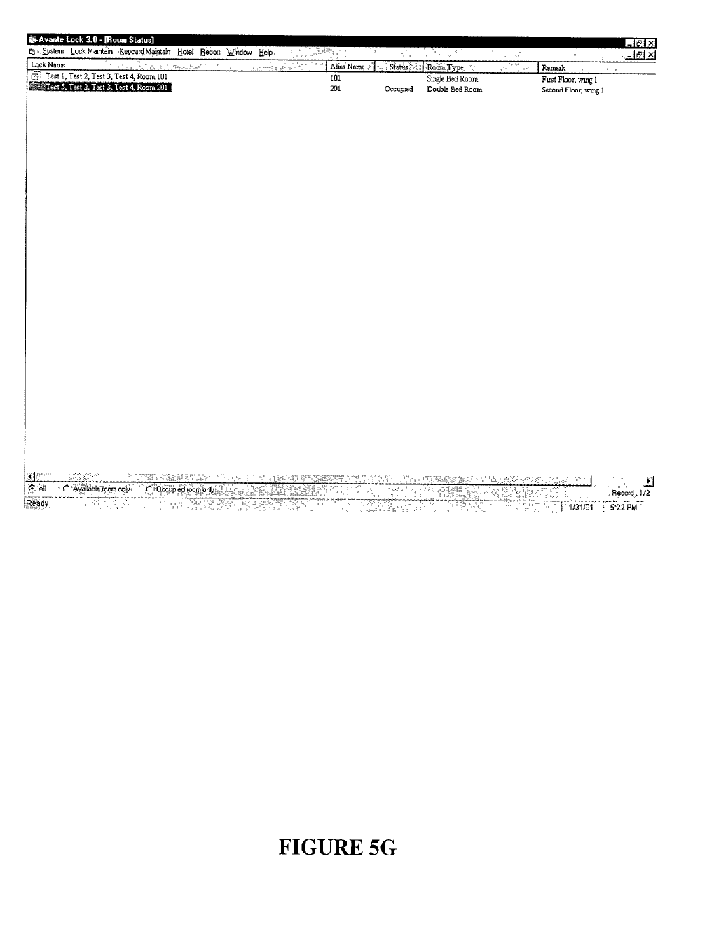

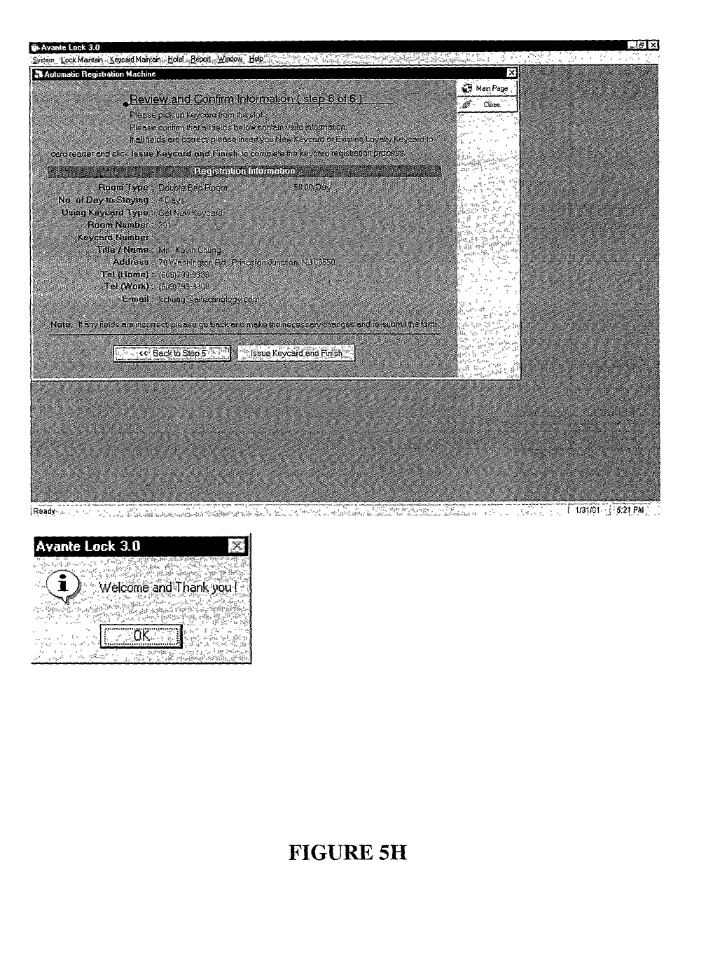

FIGS. 5A through 5H are exemplary screen displays that can be produced by the embodiment of FIG. 1 such as during the registration process of FIG. 4. It is noted that the ordering of the steps in the registration process and the design and organization of each information screen may be varied as is convenient and desired for a particular property and/or proprietor. The exemplary screen displays of FIG. 5A-5H, for example, illustrate a slightly different ordering of the process steps as compared to that of FIGS. 4 and 4A, for example. These information screens present to the user a six step process (exclusive of the welcome and check-out screens), although the steps in a flow diagram of such process may differ in function, number and/or nomenclature from what appears to the user.

The six steps of the process presented to the user are:

(1) Room type selection from among the types of rooms (e.g., suite, single, twin, double, queen, king, smoking, nonsmoking, ocean view, pool view) that are available.

(2) Entering the length of time, e.g., the number of days, the user will be staying (including the day of registration).

(3) Obtaining credit/debit verification and/or authorization.

(4) Entering of basic user (guest) information (e.g., name, address, telephone, loyalty program identification, etc.) and whether a loyalty card will be used.

(5) Selection of a particular room of the type selected in step (1).

(6) Review and confirmation of selections and information.

Upon confirmation, the ARM 10 will issue an access card 300 or will code the user's loyalty card for the selected accesses if such loyalty card is inserted into the card reader/writer 200.

The above six steps could be displayed as part of the welcome screen or as an additional screen or sequence of screens, or may be available through a “button” on the information screen. A button is an indicia that, when clicked on, takes the user to a particular information screen. For example, an “ABOUT” button, i.e. an indicia with the word “ABOUT” thereon or associated therewith, would take the user to a screen displaying the six steps of the registration process as set for the in the preceding paragraph. Similarly, a “CANCELLATION POLICY” screen or button could be provided to advise the user about the applicable cancellation policy and how to cancel a registration or obtain a credit or a refund, or such policy and information could be displayed on any one or more of the six basic information screens. As described below, one or more information screens may be provided for welcome and/or check out, as may be desirable and convenient to the proprietor.

A first information screen shown in FIG. 5A is a “welcome” information screen that may identify, for example, the proprietor, facility and/or location, and the registration system as the Automatic Registration Machine (ARM). The welcome screen includes, for example, a “Check In” button for initiating the registration or check in process, e.g., as described below in relation to subsequent screens and a “Check Out” button for proceeding to a check out information screen for checking out (such as that shown in FIG. 5H). The welcome screen also includes, for example, a “Cancellation” button for canceling or terminating a previous registration and a “View Card” button for displaying information from an access card 300 inserted into ARM user interface 100, such as to obtain access information and/or loyalty program information stored in the card 300. The welcome screen also includes a pop-up panel or box shown at the lower left of FIG. 5A entitled “Pre-registered reservation number” prompting the user to enter a reservation or confirmation number so that the information relating to that reservation can be obtained, e.g., from the property management system, a reservation system or another external source.

A second information screen shown in FIG. 5B identifies the registration system as the Automatic Registration Machine (ARM) and displays a listing of room types, prices and the status or availability of each type of room. The information screen may include an indicia to display which step in the registration process is being used, e.g., an indicia and/or the words “Type of Room (step 1 of 6)” as illustrated. Once a selection is made, the user proceeds to the next step by clicking on the button “Click here for Step 2>>” or may click on “Back to Main Page” to return to the welcome screen. This screen relates generally, for example, to a portion of step 1070 of FIG. 4.

A third information screen shown in FIG. 5C is for selecting or confirming the length of time, e.g., the number of days, that the user will be staying. The number displayed may be automatically made to correspond to a reservation or preregistration selection and may be increased or decreased by the user clicking on the “♥” button. A notice advises the user that the length of stay selected will be used for credit card and/or billing purposes, such as verifying credit and/or obtaining credit authorization. Once a selection is made, the user proceeds to the next step by clicking on the button “Click here for Step 3>>” or can return to the previous screen by clicking on the button “<<Back to Step 1.” This screen relates generally, for example, to a portion of step 1040 of FIG. 4.

A fourth information screen shown in FIG. 5D is for entering credit card information for obtaining and/or authorizing credit and/or verifying credit card information and status. The user swipes his credit card or inserts it into slot 110, and then enters his password, PIN, personal identification number, security code or other identifier, if such is required, via data entry device 130. The credit checking process is initiated by clicking on the “Submit” button. A notice advises the user that the next screen will appear if credit is approved, otherwise the user is instructed to swipe or insert the credit card again or to try a different card. If credit is not approved, it is desirable that a message be displayed on display 120 indicating what is the problem, such as the reading of the credit card was faulty or credit was denied. Once credit is approved, the user is taken automatically to the next step. ARM 10 will not issue an access card (key card) 300 if credit is not approved. The user may return to a previous information screen at any time by clicking on the button “<<Back to Step 2.” This screen relates generally, for example, to step 1020 of FIG. 4.

A fifth information screen shown in FIG. 5E is for obtaining basic information concerning the user (guest) and initiating the issuance of an access card 300. If the user is a new customer, clicking on the “Please Issue New Key Card” button takes the user to a screen for gathering basic user information, such as name, address, home telephone, work address, work telephone, e-mail address, sex (male/female) and/or other desired information. To enter the information, the user simply types on the data entry device 120 to enter information in each applicable block. If the user has a reservation or preregistration, such of the foregoing information as has previously been provided to the system, such as may be available via property management system 600, is displayed automatically. The user may also be asked whether he desires to enroll in the applicable loyalty program and given the option of clicking a button to do so. If the user is an existing or repeat customer, and is enrolled in a loyalty program, he is given the option of using his loyalty card as an access card 300 if he has it with him by clicking on the “Use Own Loyalty Key Card” button. The repeat customer also has the option of obtaining a new access card 300 by clicking on the “Please Issue New Key Card” button. The user may return to a previous information screen at any time by clicking on the button “<<Back to Step 3.” This screen relates generally, for example, to step 1080 of FIG. 4.

A sixth information screen shown in FIG. 5F is for choosing the particular room desired from the available rooms of the specific type previously selected using the second screen of FIG. 5B. A list of available rooms is displayed, preferably with the room number and the characteristics of the room, such as double bed, nonsmoking, and the location of the room in the property (e.g., building and floor). Information may be presented to the user as a listing or as a geometric or other graphical display of the rooms then available. FIG. 5G displays an exemplary room listing that includes more information than does the screen of FIG. 5F.

After making a selection or accepting the default selection by ARM 10, the user proceeds to the next step by clicking on an “Accept” button (not shown) or on the button “Click here for Step 6 >>” or may return to a previous information screen at any time by clicking on the button “<<Back to Step 4.” This screen relates generally, for example, to a portion step 1070 of FIG. 4.

A seventh information screen for the sixth and final step (step 6 of 6) shown in FIG. 5H displays information as to the particulars of the selected registration for review and confirmation by the user. Confirmation is acknowledged by clicking the “Issue Key Card and Finish” button, although the button could be designated as a “Continue” button or a “Confirm” button. Upon confirmation, ARM system 10 proceeds to issue a new access card 300 or to code the user's loyalty card, if that has been selected by the user. A message to pick up the access card (key card) 300 from the slot 210 may be displayed or a pop-up box or panel, such as the “Welcome and Thank you” panel illustrated, may appear to indicate completion of registration. After a given period of time or upon clicking of the “OK” button, the panel disappears and the system again displays the welcome screen to indicate that it is ready for the next user. The user may return to a previous information screen at any time by clicking on the button “<<Back to Step 5.” This screen relates generally, for example, to step 1040 of FIG. 4 for a preregistered user or to a portion of step 1070 of FIG. 4 where a preregistration does not exist or has been changed.

The user may make a reservation, preregistration or other advance booking using a telephone or by computer, such as via the Internet or other network, or other communication link, and may use the confirmation number or other identifier associated with such reservation, preregistration or other advance booking to register using ARM 100. Registration is accomplished by entering registration information including the confirmation number (and possibly only the confirmation number) at ARM 100 which then obtains registration information from or via property management system 600 or another reservation system. Entering the confirmation number may thus utilize registration information previously provided, thereby to accomplish many of the steps otherwise accomplished in on-site registration. Entering of the confirmation number can immediately lead to issuance of access card 300 based upon the preregistration information.

In addition, a checkout screen is typically provided. A user desiring to check out, i.e. complete a transaction, either at the time selected at registration or check in or at an earlier time, inserts his access card 300 into the slot 110 of the ARM user interface 100 or slot 210 of card issuing device 200, and/or inserts his credit card into slot 110, as directed. The user then clicks on a “Check Out” button or a “Cancel Other Scheduled Stay” button or a “Check out and cancel any other scheduled stay” button, as is provided and as best reflects the user's desire. Where the welcome screen such as that of FIG. 5A is also utilized for initiating check out and/or canceling the remainder of a registration, a separate check out screen may be eliminated. User interface 100 then displays the check-out screen containing such information as the customer's name, room number, number of days already stayed, number of days scheduled to stay and the number canceled, room charges, other charges such as for itemized telephone, restaurant, other food, laundry and the like, applicable taxes, if any, and the total amount of the charges. ARM 10 then processes billing and/or payment via system 700 and, optionally, causes a printed or other tangible receipt 150 to be issued. To this end, user interface 100 includes a conventional printer or the like for providing receipt 150.

FIG. 6 is a schematic block diagram of an exemplary electronic lock 400 suitable for use in accordance with the invention. Electronic locks 400 suitable for use in conjunction with ARM 10 include electronic locks activated by magnetic stripe cards 300 and preferably smart cards 300, for example. Each electronic lock 400 includes an electrical latch 450 activatable for enabling access to a facility 500 such as a guest room, health facility, other area and the like, or for enabling use of a device 500 such as a television, telephone, exercise apparatus and the like. Latch 450 is typically an electromechanical mechanism where access involves enabling operation of a physical barrier, such as a door or portal, and is typically an electronic switch, relay or other electrical device where access involves rendering an apparatus operable.

Electronic lock 400 includes a reader 440 that reads information from an access card 300 inserted into a slot 410 of electronic lock 400 for selectively effecting access. Electronic lock 400 includes a processor 420 and a memory 430 for operably comparing in any suitable manner information read from the access card 300 with access information stored in the lock memory 430. Electronic lock 400 also includes a battery or other source 460 of power for operating its processor 420, memory 430, reader 440 and latch mechanism 450, and, optionally, may be operably coupled via a communication link 470, such as a network, LAN, Ethernet, radio link or cabling, to user interface 100 or property management system 600, for communicating access information, facility usage information, service usage information and/or other information therebetween.

One suitable electronic lock 400 is the Avante Smart Card Electronic Lock type SCL3000 commercially available from the Avante International Technology affiliate of Al Technology, Inc., located in Princeton Junction, N.J. 08550, which is operable in conjunction with smart cards for providing selective access, such as to hotel rooms, offices and the like. This Avante electronic lock, which is operable with contact-type smart cards including the preferred Infineon (Seimens of Germany) integrated circuit chip described below, has been in use since 1996 in many facilities such as apartments, stores, offices, gates and other facilities in the United States, Hong Kong and Macao without reported security breach or malfunction. The number of electronic locks that may be utilized is typically between 100 and 10,000 in any one or more affiliated facilities, properties or location or other premises, but may be a lesser or greater number. Where such systems are intended for controlling access on a more “permanent” or long-term basis as compared to a lodging context where users change on a day-to-day basis, canceling of issued access cards with regard to a specific smart card lock is typically accomplished by issuing an access card having cancellation information coded therein, and then using that card in the specific lock. This and other changes to the information stored in the memory of the electronic lock may be made either by a “cancellation card” as needed or by a “management card” having a higher-level of access authorization as described herein.

As a practical matter, the number of such electronic locks is essentially unlimited because a relatively small record, e.g., typically less than one kilobyte, is stored for each lock and virtually any number of such records can be stored on a conventional computer hard drive having a capacity of 20 gigabytes, or 50 gigabytes or more. An individualized facility code that is written into the firmware of the lock memory can be “personalized” or customized for any particular location or other premises, aggregations of locations or other premises, or portions of a location or other premises. Electronic locks 400 in each section or portion of such location or other premises may be specially coded, e.g., with codes representative of such section or portion, for providing additional security. Records of the cards 300 utilized to seek access by any electronic lock 400 may be stored in memory 420 thereof, and may include information as to the card used, whether access was granted or denied, the date and time of the use. Electronic lock 400 typically stores records of the last200 card uses or uses, and optionally stores records of the last 2000 uses or entries, but preferably at least 100 records of use. Additionally or alternatively, such records of use may be stored in the memory of each smart card 300.

Any desired access or limitation thereof may be coded into the memory of card(s) 300, such as coding a plurality of access cards 300 to enable access to any particular electronic lock 400, coding access card(s) 300 for a single use, for plural uses or for unlimited uses, and coding access card(s) for use on any particular date or dates and/or time or times on such date(s). Such coding options allow a property manager to authorize guests access only to those guest facilities for which the guest is registered, to authorize particular employees or contract workers access only to those operation and maintenance facilities as each of such employees or workers needs access in the performance of his or her assigned duties (e.g., cleaners to a laundry and linen storage and to guest rooms assigned to be cleaned, service technicians to furnace rooms, air conditioning machinery and the like), and to authorize particular hotel staff access to specific administrative offices, reception desk areas, cashier cages and the like or to certain systems such as property management system 600 or personnel system 800.

An access control system suitable for use with and compatible with the Avante electronic locks is the Avante Access Control also available from Avante International Technology, for example, version 3.0 thereof. The Avante Access Control 3.0 operates on any computer running Windows® or Windows® NT, for example, and provides the access control functions of property management system 600, generates information to be coded into the memories of access cards 300, and has provision for links, if utilized, to electronic locks 400. The linking of Avante Access Control to locks 400 is expanded in the present invention to also encompass facilities 500.

An operator of the computer on which Avante Access Control is running may specify the system definition and password, define and maintain listings of the various areas and facilities, and or regions therein, and the electronic lock 400 or facility access device 500 associated therewith and the access codes to be utilized therewith. The operator may also establish and define three or four levels of access and security as described above and the access cards that are to be issued in relation to each. The above may be for one property or location or other premises or for plural properties at one ore more locations or other premises. In addition, electronic locks 400 to be utilized therewith may be initialized by storing in the memory 430 therein desired security codes, PSC and other identifiers as desired, and setting the correct time and date for the clock function thereof. The foregoing information established using the Avante Access control is further utilized when providing access cards 300 for storing therein the information appropriate to the type and kind of access to be permitted the user of such card 300.

Smart cards for use with Avante electronic locks and the Avante access control system preferably employ an electronic device such as the Infineon chip available from Siemens located in Germany. The Infineon chip, which has been available for more than ten years and is utilized for financial transactions and other high-security applications, provides a secured memory 430, available in particular memory capacities in the range of 2-8 kilobytes (and higher if needed), and utilizes a property security coding (PSC) that offers a high degree of security. An Infineon chip smart card utilized in conjunction with the Avante electronic lock provides three levels of hardware, firmware and software security codes. The PSC written into the electronic locks 400 and correspondingly into the smart card access cards 300 to be used therewith can be “personalized” or customized by the management of the property or location from the common PSC code entered by the manufacturer, so that even the manufacturer such as Avante cannot gain access unless given the new PSC or otherwise authorized by the management. The PSC is written into a special zone of the chip memory 430 for which, by operation of the processor 420, the data written therein cannot be deduced, read or changed without prior knowledge of the particular value of such PSC. Processor 420 preferably operates to permanently void any access card 300 after a given number of attempts, e.g., three, to use it in a lock having a different PSC.

ARM 10 is typically implemented utilizing a conventional computer running a conventional operating system, for example, a DOS or Windows® operating system. Preferably, ARM 10 includes 32-bit Windows® based software that is fully compatible with Windows®, Windows® NT and Novell® computer networks and software. As a result, ARM 10 may usually be directly and easily interfaced with available property management systems 600 or other booking/registration systems, such as those utilized by many hotel and lodging companies, or specialized or customized such systems. ARM 10 provides an operator interface for use by guests or facility staff or other users for providing access cards 300, and preferably one that is simple-to-use.

Returning to FIG. 1 with respect to user interface 100, slot 110 thereof is typically associated with a credit card/debit card reader that can be a conventional reader for magnetic stripe cards and/or smart cards into which a customer or other user inserts the appropriate card and usually a PIN or other personal identifier. This credit card reader reads information stored in the memory of the user's credit card and confirms credit availability and receives credit authorization from the appropriate credit card company, bank, clearing house and the like. Such credit card reader may be of like type to that utilized in conventional terminals such as automatic teller machines (ATM), automatic gasoline pumps or other point-of-sale (POS) terminals and the like.

Personnel management system 800 may be utilized in conjunction with the ARM system 10 thus far described and is linked thereto, such as through an ARM user interface 100 as shown in FIG. 1, to manage and control personnel at a property or location or other premises. Such personnel may include employee and/or contractor personnel and/or other workers (herein “workers”). Personnel management system 800 may be linked to one or more of the user interfaces 100 utilized by users (e.g., guests or customers) for registration at the property or location or other premises or may be linked to one or more separate user interfaces 100, perhaps located where convenient for use by employees, such as at an employee parking lot, employee entrance, service entrance, locker room or the like.

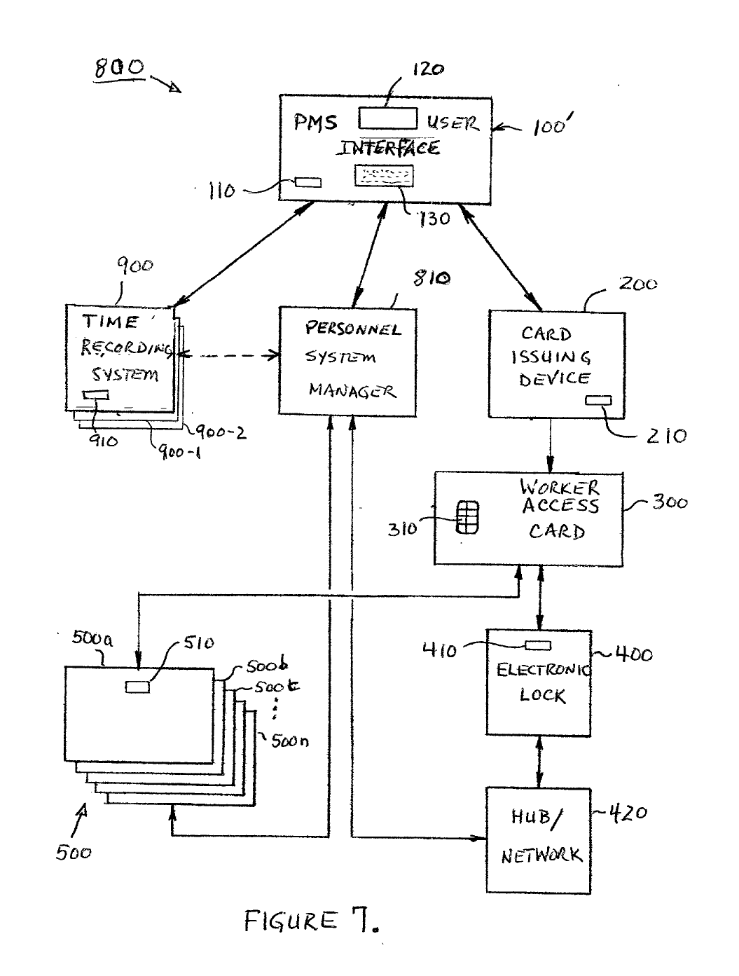

FIG. 7 is a schematic block diagram of a personnel management system 800 in accordance with the invention that utilizes or certain elements of the automatic registration system 10 of FIG. 1 and/or shares utilization of such elements. Preferably, personnel management system (PMS) 800 includes a personnel system manager 810 that is linked to a PMS user interface 100′ that is the same as ARM user interface 100 described above except that certain features thereof such as the information screens displayed are customized for use in the management and control of employees and other workers. Alternatively, personnel management system 800 may utilize ARM user interface 100 as described above rather than a separate PMS interface device 100′.

Personnel system manager 810 includes a computer having a processor and a memory that may be utilized to manage and control personnel at the property or location or other premises. The computer and associated software of PMS manager 810 is utilized for retrieving and recording information relating to time entries, such as times and locations of clocking in and clocking out, for all workers at a property or location or other premises. PMS 800 includes, for example, links to card issuing device 200 for providing worker access cards 300 to workers, links to various electronic locks 400 and facilities and equipment and other functions 500 located at the property, and may provide via use of display 120 of user interface 100 or 100′ illustrations of the property and the facilities thereof as well as work rules, safety rules, company policies and procedures, maintenance manuals and other information to which workers are required to have access or may have a need to access or may desire to access.

Individuals become registered as workers by following instructions on a sequence of information displays presented on display 120 of user interface 100, 100′ in similar manner to the registration/check-in process described above in relation to guests and other users. Upon proper completion of such registration process, a worker access card 300 is issued to the worker by card issuing device 200.

A worker inserts his worker access smart card 300 into a slot of a smart card reader, such as slot 110 of user interface 100, 100′ or slot 910 of time clock station 900, when checking in (reporting or “clocking in”) for work and when checking out (leaving or “clocking out”) from work, which at management option may or may not included clocking out and clocking in for meals, breaks and the like. Worker access card 300 is a smart card identical to access card 300 described above except that the information stored therein relates to the worker's work-related access needs rather than a guest user's access, purchases, and loyalty program. Optionally, worker card 300 may have different external indicia, possibly including a photograph of the worker, so as to serve as worker identification apart from systems 10 and 800.

Personnel management system 800, 810 is linked to time recording system 900 either via user interface 100′ or directly (phantom double-ended arrow), or indirectly using a data transfer card as described below. Time recording system 900 includes one or more “time clock” stations 900, 900-1, 900-2 and so forth at which workers may clock in or clock out by inserting their worker access card 300 into slot 910 therein. Each time clock station includes a smart card reader receiving the worker smart card inserted into slot 910 for reading information from the worker's smart card 300, a memory for storing information read from the worker access cards 300, and a processor for controlling the operation of the card reader and the memory in like manner, for example, to of reader 410, processor 420 and memory 430 of electronic lock 400 described above, or to user interface 100 and card device 200 described above. Each time clock also includes a battery or other source of electrical power for maintaining operation of processor 420 which typically includes a clock function for keeping track of time and date, or of a separate clock circuit, and may also have a display device for displaying information, such as the time and date or other work-related information, of either a worker-specific or company-wide nature, to the worker.

Each time a worker clocks in or clocks out, a record thereof including the time and date thereof is stored in the memory of the time clock station 900 and in the memory of the worker's smart card 300. Information is collected, e.g., for payroll, time and attendance or other management purpose, in any of a variety of ways. Information may be transferred via a communications link between personnel management system 900 (e.g., including any one or more time clock stations thereof) and one of user interface 100, 100′, or a personal computer. Such personal computer may be the processor utilized in personnel manager 810, in user interface 100, 100′, or in property management system 600, for example.

Alternatively, such information may be transferred from the memory of time clock station 900 to a data-transfer card inserted into slot 910 thereof and then inserting that data card into one of slots 110, 210 of user interface 100 or card device 200, or into the slot of a card reader associated with a personal computer which reads the information stored therein. The data-transfer card is a smart card of like type to that of access card 300 except that identifier codes have been entered into its memory to identify it as a data card and to operate time clock station 900 to transfer data thereto. For applications where the memory of time clock station 900 is of large capacity, the memory of the data-transfer card may be of compatible capacity greater than the memory capacity of access cards 300. Additionally, where the complete record of worker activity is stored in the memory of that worker's access card 300, the worker's access card 300 is inserted card into one of slots 110, 210 of user interface 100 or card device 200, or into the slot of a card reader associated with a personal computer for transferring such information.

One suitable personnel management system 900 of the sort described is the TIME MESSENGER™ time-attendance and access recorder system available from Avante International Technology of Princeton Junction, N.J. 08550, which is compatible with the Avante Access Control system and Avante electronic locks described above.

The present invention can be embodied as a computer implemented process or processes and/or apparatus for performing such computer-implemented process or processes, and can also be embodied in the form of a tangible storage medium containing a computer program or other machine-readable instructions (herein “computer program”), wherein when the computer program is loaded into a computer or other processor (herein “computer”) and/or is executed by the computer, the computer becomes an apparatus for practicing the invention. Storage media for containing such computer program include, for example, floppy disks and diskettes, compact disks (CD)-ROMs (whether or not writeable), DVD digital disks, RAM and ROM memories, computer hard drives and back-up drives, and any other storage medium readable by a computer. The invention can also be embodied in the form of a computer program, for example, whether stored in a storage medium or transmitted over a transmission medium such as electrical conductors, fiber optics or other light conductors, or by electromagnetic radiation, wherein when the computer program is loaded into a computer and/or is executed by the computer, the computer becomes an apparatus for practicing the invention. The invention may be implemented on a general purpose microprocessor or on a digital processor specifically configured to practice the invention. When a general-purpose microprocessor is employed, the computer program code configures the circuitry of the microprocessor to create specific logic circuit arrangements.

While the present invention has been described in terms of the foregoing exemplary embodiments, variations within the scope and spirit of the present invention as defined by the claims following will be apparent to those skilled in the art. For example, while the description and figures herein may generally show an arrangement including one user interface 100, card issuing device 200, access card 300, electronic lock 400 or the like, the invention may utilize one or more of such devices and typically does include plural such elements, and may also interface with one or more property management systems 600, billing/payment systems 700 or personnel management systems 900. Further, any of the foregoing may be located at one or more properties or locations or other premises.

In addition, whereas property management system 600, billing/payment system 700, personnel management system 800, for example, are each described as including a processor, a processor such as personal computer or network thereof may serve as the processor for any one or more of the foregoing, each system being defined by one or more computer programs stored therein and operated for causing the computer to perform the described function(s) and operation(s).

While the description herein is generally in the context of a hotel, inn, motel, resort or other lodging or hospitality property, the apparatus and system of the invention may be utilized an many different businesses and contexts. Such include but not limited to access to schools, libraries, hospitals, offices, factories, and other businesses, ticketing for airlines trains and other forms of transportation as well as access to amenities such as lounges and special waiting areas, ticketing for movies, plays, sporting events, and other forms of entertainment, ticketing of other events and venues, rental and leasing of self-storage units, automobiles, trucks and the like wherein the access card may enable access to fueling and other services as well as to the vehicle yard and the vehicle and to enable its operation, for participants at conferences, conventions and other events; in other words, in any context in which access is to be controlled and in particular to where different access is to be made available for different persons.

what is claimed is:

1. Registration apparatus associated with a premises comprising:
a processor and a memory operably coupled thereto;
a user interface including a display for displaying registration information relating to the premises and a data entry for entering user information, said user interface being operably coupled to said processor for coupling the registration information and the user information therebetween; and
a card issuing device for providing an access card having a card memory, said card issuing device being operably coupled to said processor for coupling information related to the registration information and the user information to be stored in the card memory of the access card for enabling access related to the premises.

2. The registration apparatus of claim 1 wherein the registration information relates to at least one of rooms, areas, facilities and services at the premises and at least one of the status and availability of same.

3. The registration apparatus of claim 2 wherein the user information includes selection of at least one of rooms, areas, facilities and services at the premises.

4. The registration apparatus of claim 1 wherein said card issuing device includes a card writer for writing information to the card memory of the access card.

5. The registration apparatus of claim 4 wherein the card memory is one of a magnetic stripe and an electronic memory.

6. The registration apparatus of claim 1 in combination with at least one access card wherein the access card is one of a magnetic stripe card having a magnetic memory stripe and a smart card having a processor and an electronic memory.

7. The registration apparatus of claim 1 in combination with at least one access device adapted for enabling access responsive to the information stored in the memory of the access card.

8. The registration apparatus of claim 1 in combination with a property management system providing at least part of the registration information.

9. The registration apparatus of claim 1 wherein the user information includes at least one of personal information, credit information, identifying information, loyalty program information and selection of at least one of rooms, areas, facilities and services at the premises.

10. The registration apparatus of claim 1 wherein the information related to the registration information and the user information includes an identifier of at least one of rooms, areas, facilities and services at the premises for which access using the access card is authorized.

11. The registration apparatus of claim 1 wherein at least one of the registration information and the user information includes, at least in part, information communicated to said processor from a source external to said registration apparatus via a communication link.

12. The registration apparatus of claim 11 wherein said communication link includes one of a network, telephone and the Internet.

13. A registration system associated with premises comprising:
a processor and a memory operably coupled thereto;
a user interface including a display for displaying registration information relating to the premises and a data entry for entering user information, said user interface being operably coupled to said processor for coupling the registration information and the user information therebetween;
a card issuing device for providing an access card having a card memory, said card issuing device being operably coupled to said processor for coupling information related to the registration information and the user information to be stored in the card memory of the access card for enabling access related to the premises; and
at least one access device adapted for enabling access to at least one portion of the premises responsive to the information stored in the memory of the access card.

14. The registration system of claim 13 wherein the registration information relates to at least one of rooms, areas, facilities and services at the premises and at least one of the status and availability of same.

15. The registration system of claim 14 wherein the user information includes selection of at least one of rooms, areas, facilities and services at the premises.

16. The registration system of claim 13 wherein said card issuing device includes a card writer for writing information to the card memory of the access card.

17. The registration system of claim 16 wherein the card memory is one of a magnetic stripe and an electronic memory.

18. The registration system of claim 13 in combination with a plurality of access cards wherein the access card is one of a magnetic stripe card having a magnetic memory stripe and a smart card having a processor and an electronic memory.

19. The registration system of claim 13 in combination with a plurality of access cards wherein the access card is one of a contact-type smart card and a wireless-type smart card.

20. The registration system of claim 13 in combination with a property management system providing at least part of the registration information.

21. The registration system of claim 20 wherein said property management system is run on said processor.

22. The registration system of claim 20 wherein said at least one access device is operably coupled to one of said processor and said property management system.

23. The registration system of claim 13 wherein the user information includes at least one of personal information, credit information, identifying information, loyalty program information and selection of at least one of rooms, areas, facilities and services at the premises.

24. The registration system of claim 13 in combination with means coupled to said user interface and responsive to a credit card for effecting at least one of credit verification, credit authorization, billing and payment.

25. The registration system of claim 24 wherein said means for effecting is responsive to a smart card credit card and/or a magnetic stripe credit card.

26. The registration system of claim 13 wherein at least one of the registration information and the user information includes, at least in part, information communicated to said processor from a source external to said registration system via a communication link.

27. The registration system of claim 26 wherein said communication link includes one of a network, telephone and the Internet.

28. The registration system of claim 13 wherein the at least one access device includes a given electronic lock providing selective access to a given portion of the premises, and wherein the information stored in the card memory of a given access card is for enabling access to that given portion during a predetermined period of time, said given electronic lock including a clock for providing the selective access to the given portion only during the predetermined period of time.

29. The registration system of claim 13 wherein worker-related information is stored in the card memory of the access card, in combination with at least one time-clock station responsive to the worker-related information for recording at least time information relating to a worker.

30. The registration system of claim 13 wherein the access card is a loyalty card.

31. The registration system of claim 13 wherein the access card includes at least one of an accessible memory into which information can be stored and a secure memory storing unchangeable information for providing one of different levels of access and security.

32. The registration system of claim 13 wherein said premises includes at least one of a hotel, motel, resort, lodging and hospitality facility, and wherein said at least one access device includes at least an electronic lock for a room.

33. The registration system of claim 32 in combination with a property management system providing registration information relating to availability of rooms.

34. The registration system of claim 13 wherein said user interface further includes means for providing a tangible receipt.

35. The registration system of claim 34 in combination with a property management system providing charge information relating to charges to an account, wherein insertion of one of the access cards related to a given account into said user interface causes the property management system to provide charge information related to the given account and causes said means for providing to provide the tangible receipt including the charge information.

36. A electronic registration system associated with a premises including a number of spaces, said system comprising:
at least one processor and at least one memory operably coupled thereto;
a property management system including a computer program stored in said at least one memory and operating in conjunction with said at least one processor;
a plurality of electronic access devices each adapted for enabling access to one of the spaces of the premises responsive to information stored in the card memory of an access card;
an access control system including a computer program stored in said at least one memory and operating in conjunction with said at least one processor for defining access parameters for said plurality of electronic access devices;
a user interface operably coupled to said at least one processor and said property management system for registering a user in relation to at least a given one of the spaces of the premises; and
a card issuing device operably coupled to said at least one processor for storing registration information from said property management system and access parameters from said access control system in the card memory of a given access card for providing the given access card in response to registering a user for the given space, the given access card enabling at least one of said plurality of electronic access devices for access to the given space.

37. The electronic registration system of claim 36 further comprising a personnel management system including a computer program stored in said at least one memory and operating in conjunction with said at least one processor for defining parameters relating to at least one worker, wherein said card issuing device issues a second given access card having parameters relating to a given worker of the at least one worker stored in the card memory thereof.

38. The electronic registration system of claim 37 further comprising at least one time clock station responsive to the second given access card for recording information stored therein.

39. The electronic registration system of claim 38 wherein said at least one time clock station records the information relating to the second given access card in one of the card memory of the second given access card and a memory included in said time clock station.

40. The electronic registration system of claim 37 wherein said second access card has information stored in its card memory for enabling predetermined ones of said electronic access devices for access to predetermined ones of the spaces at the premises.

41. The electronic registration system of claim 36 wherein the access card is a loyalty card adapted for storing registration information relating to a plurality of registrations.

42. The electronic registration system of claim 36 wherein said plurality of electronic access devices include an electronic lock having a clock therein providing time information.

43. The electronic registration system of claim 42 wherein said electronic lock either compares time information from the access card to time information from said clock or records time information from said clock in at least one of the card memory and a memory in said electronic lock, or both.

44. The electronic registration system of claim 36 wherein the access card is one of a magnetic stripe card and a smart card including a processor and a memory.

45. The electronic registration system of claim 36 wherein at least ones of said plurality of electronic access devices are operably coupled to said at least one processor.

46. The electronic registration system of claim 36 wherein the registration information includes, at least in part, information communicated to said processor from a source external to said electronic registration system via a communication link.

47. The electronic registration system of claim 46 wherein said communication link includes one of a network, telephone and the Internet.

48. A method for registering a user comprising:
providing a user terminal;
providing a plurality of electronic access devices each operable responsive to an access card having certain information stored in a memory thereof to provide access to a facility or facilities;
entering and displaying registration information using the user terminal;
allowing the user to use the user terminal to change the registration information;
allowing the user to use the user terminal to select the facility or facilities to which the user is to have access;
storing information representative of the registration information, the changed registration information, if any, and the selected facility or facilities into a computer;
storing certain information representative of the registration information, the changed registration information, if any, and the selected facility or facilities into the memory of the access card; and
providing the access card with the certain information representative of the registration information, the changed registration information, if any, and the selected facility or facilities stored in the memory thereof, whereby the access card may be used with the electronic access devices to gain access to the facility or facilities.

49. The method of claim 48 after the access card has been used in at least one electronic access device which stores use information in the memory of the access card, further comprising:
placing the access card operably proximate the user terminal for reading the use information stored in the card memory thereof; and
completing a transaction using the information representative of the registration information, the changed registration information, if any, and the selected facility or facilities stored in the computer and the use information from the access card.

50. The method of claim 49 wherein said completing the transaction includes at least one of effecting billing and/or payment and providing a tangible receipt containing information relating to the transaction.

51. The method of claim 48 wherein said entering includes at least one of placing a credit card operably proximate the user terminal and entering credit information for initiating a credit transaction, and wherein said displaying includes displaying information relating to the credit transaction.

52. The method of claim 51 wherein the credit transaction includes at least one of verifying credit, authorizing credit, billing, and payment.

53. The method of claim 48 wherein said storing certain information and said providing an access card include: placing a loyalty card operably proximate the user terminal, storing the certain information in a memory of the loyalty card as an access card, and providing the loyalty card as the access card.

54. The method of claim 48 wherein said entering registration information includes at least one of communicating information from a property management system, obtaining information from a credit card, communicating information with a billing/payment system, and communicating information with a personnel management system.

55. The method of claim 48 wherein said entering and displaying includes obtaining at least part of the registration information from a source external to said user terminal.

56. The method of claim 55 wherein said obtaining includes communicating preregistration information via one of a network, telephone and the Internet.

57. A time recording and access control system associated with a premises including a number of spaces, said system comprising:
at least one processor and at least one memory operably coupled thereto;
a plurality of electronic access devices each adapted for enabling access to one of the spaces of the premises responsive to the information stored in the card memory of an access card;
an access control system including a computer program stored in said at least one memory and operating in conjunction with said at least one processor for defining access parameters for said plurality of electronic access devices;
a user interface operably coupled to said at least one processor and said property management system for registering a user in relation to at least a given one of the spaces of the premises;
a card issuing device operably coupled to said at least one processor for storing registration information from said user interface and access parameters from said access control system in the card memory of a given access card for providing the given access card in response to registering a user, the given access card enabling at least one of said plurality of electronic access devices for access to the given space; and
at least one time clock station including a clock for providing time information and responsive to the given access card for recording information relating to the given access card.

58. The system of claim 57 wherein said user interface registering a user includes said at least one processor obtaining at least part of the registration information from a source external to said system via a communication link.

59. The system of claim 58 wherein said communication link includes one of a network, telephone and the Internet.

60. The system of claim 57 further comprising a personnel management system including a computer program stored in said at least one memory and operating in conjunction with said at least one processor for defining parameters relating to at least one worker, wherein said card issuing device provides the given access card having parameters relating to a given worker stored in the card memory thereof.

61. The system of claim 57 wherein said at least one time clock station records the information relating to the given access card in one of the card memory of the given access card and a memory included in said time clock station.

62. The system of claim 57 wherein the given access card has information stored in its card memory for enabling access by predetermined ones of said electronic access devices.

63. The system of claim 57 wherein said electronic access control devices either compares time information from the access card to time information from said clock or records time information from said clock in at least one of the card memory and a memory in said electronic access device or both.

64. The system of claim 57 wherein the access card is one of a magnetic stripe card and a smart card including a processor and a memory.

65. The system of claim 57 wherein at least ones of said plurality of electronic access devices are operably coupled to said at least one processor.

66. A storage medium encoded with machine-readable computer instructions for registering a user using a user terminal comprising:
means for causing the computer to enter and display registration information on a user terminal;
means for causing the computer to allow the user to use the user terminal to change the registration information;
means for causing the computer to allow the user to use the user terminal to select a facility or facilities to which the user is to have access;
means for causing the computer to store information representative of the registration information, the changed registration information, if any, and the selected facility or facilities into the computer;
means for causing the computer to store certain information representative of the registration information, the changed registration information, if any, and the selected facility or facilities into the memory of an access card in format adapted for operating an electronic access device associated with the selected facility or facilities; and
means for causing the computer to provide the access card with the certain information representative of the registration information, the changed registration information, if any, and the selected facility or facilities stored in the memory thereof,
whereby the access card is adapted to be used with an electronic access device to gain access to the selected facility or facilities.

67. The storage medium of claim 66 wherein said means for causing the computer to enter and display registration information includes communicating credit information with one of a credit card having a memory and a computer billing/payment system.

68. The storage medium of claim 48 wherein said means for causing the computer to enter and display registration information includes means for causing the computer to obtain at least part of the registration information from a source external to said computer.

69. The storage medium of claim 68 wherein said means for causing the computer to obtain includes communicating preregistration information via one of a network, telephone and the Internet.
